(19) United States
(12) Patent Application Publication
(10) Pub. No.: US 2009/0145957 A1
(43) Pub. Date: Jun. 11, 2009

(54) Intelligent triggering for data capture applications

(75) Inventor: Ron Zancola, West Sayville, NY (US)

Correspondence Address: Motorola- Amin, Turocy & Calvin, LLP, 127 Public Square, 57th Floor, Key Tower, Cleveland, OH, 44114, US

(73) Assignee: SYMBOL TECHNOLOGIES, INC., Holtsville, NY (US)

(21) Appl. No.: 11/953,730

(22) Filed: Dec. 10, 2007

(51) Int. Cl. G06F 17/00; G08B 26/00

(52) U.S. Cl. 235/375; 340/505

(57) ABSTRACT

Systems, devices and/or methods that facilitate optimized proximity based information acquisition devices and/or systems. Employing dynamically adjustable interrogation ranges, interrogation directionality, and/or interrogation modalities can result in more optimized power consumption and higher selectivity among targets. Where power consumption is optimized, smaller batteries can be used and/or longer use times can be realized. Further, higher selectivity by reducing interrogation ranges, selecting directionally restricted interrogations, and filtering by modality can result in acquiring data from unintended targets.

### TECHNICAL FIELD

The subject innovation relates generally to proximity based information acquisition systems, methods, and/or devices and more particularly to adaptive interrogation devices, methods, and/or systems to facilitate more optimized proximity based information acquisition devices and/or systems.

### BACKGROUND

Traditionally, proximity based information acquisition systems and/or devices, such as radio frequency identification (RFID) systems and laser barcode scanners, among others, employ interrogation systems (e.g., RFID transponders, laser sources, . . . ) at a predetermined power level when interrogating targets (e.g., RFID tags, bar codes, . . . ). This predetermined power level conventionally determines the region in which data can be reliably acquired. For example, a laser scanner can acquire data from a barcode from up to 1 meter. In another example, an RFID scanner can acquire data from RFID tags within 3 meters.

These conventional interrogation systems can result in non-optimal proximity based information acquisition device and/or system performance. Where, for example, an interrogation system interrogation condition is fixed (e.g., the power and direction of the interrogation is fixed, among others) power consumption and singularity can be less than optimal. For instance, where an RFID scanner emits an omnidirectional interrogation signal at, for example, 0.1 watts, data from RFID tags within, for example, 3 meters from the scanner can be acquired. However, where RFID tags are much closer, for example within 0.1 meters, a significantly lower interrogation power can be used to interrogate those RFID tags. Thus, the exemplary RFID scanner power consumption is not optimal for scanning RFID tags located substantially closer than the predetermined power to range relationship.

Continuing the example, where a plurality of RFID tags are present in a predetermined power to range relationship, data can be returned from more than the intended target of the interrogation. This can result in excessive data being presented to the user. For example, where an RFID scanner is employed in a hospital to track medications, a range of 3 meters may return medication information for multiple patients in a single recovery ward. These same concerns are present in other proximity based information acquisition systems and/or devices. For example, where a laser scanner with a range of 1 meter can be appropriate for a parcel delivery service scanning bar codes on boxes, the power consumption can be excessive where a laser scanner is used to scan tickets at a sporting event where ticket barcodes are commonly within mere centimeters of the scanner device.

Interrogation conditions in conventional devices also generally do not adjust the shape of an interrogation signal. For example, in the RFID system, the scanner can be set to broadcast an omnidirectional signal that can return RFID tag information from a substantially spherical region around the scanner. Where there are RFID tags both behind and in front of a user, a spherical region can be undesirable. Similarly, a barcode scanner can, for example, produce a laser scan of a region 1 meter wide. Thus, where barcodes are spaced, for example, 3 cm apart (e.g., on a line of small packages, book spines, . . . ) a narrower laser scan region can be desirable.

### SUMMARY

The following presents a simplified summary of the subject innovation in order to provide a basic understanding of some aspects described herein. This summary is not an extensive overview of the disclosed subject matter. It is intended to neither identify key or critical elements of the disclosed subject matter nor delineate the scope of the subject innovation. Its sole purpose is to present some concepts of the disclosed subject matter in a simplified form as a prelude to the more detailed description that is presented later.

Conventionally, proximity based information acquisition systems and/or devices lack dynamic adjustment of interrogation conditions (e.g., interrogation power, direction, mode, . . . ). This can result in a user having to adapt to an interrogation device rather than the interrogation device adapting to the user's conditions and requirements. Further, conventional systems and devices can result in poorly optimized power consumption (e.g., smaller batteries can be used or typical batteries can last longer where power consumption is better optimized). Moreover, conventional systems can result in inadequate interrogation (e.g., returning too much or too little data) because of the typical use of a predetermined interrogation condition for data acquisition.

In accordance with one aspect of the disclosed subject matter, a dynamic interrogation component can be employed to facilitate more optimized proximity based information acquisition devices and/or systems. For example, employing a dynamic interrogation component can enable, for example, an RFID scanner device to have dynamically adjustable interrogation ranges and/or dynamically adjustable directional interrogation. This can result in, for example, consuming less power to scan near RFID tags, selectively scanning near RFID tags in a target rich environment, selectively scanning RFID tags in a particular spatial region, or combinations thereof, among others. Similarly, numerous other interrogation systems and/or devices can benefit from dynamic control of the interrogation condition, such as, a laser barcode scanner can use less power and/or be more target selective, among many others.

In accordance with another aspect of the disclosed subject matter, a device or system end user can interact with the dynamic interrogation component to select parameter(s) appropriate to the particular conditions to aid in optimizing the interrogation condition. For example, a barcode scanner trigger can be actuated by a user once for near barcodes (e.g., low power scan), twice for medium range barcodes (e.g., medium power scan), and three times for distant bar codes (e.g., high power scan). Another example can be that the user selects option buttons on a barcode scanner to select laser beam scan region parameters (e.g., wide or narrow scans, among others).

In accordance with another aspect, the user can interact with an interrogation system or device to select interrogation conditions, such as, modalities of interrogation. For example, a user can select an option to scan for a certain type of target, such as, low frequency RFIDs (LFRFID), high frequency RFIDs (HFRFID), ultra-high frequency RFIDs (UHFRFID), or combinations thereof, among others. Similarly, for example, laser scanners can selectively scan 1-dimensional or 2-dimensional barcodes, among others.

In accordance with another aspect of the subject innovation, inferences can be determined by an inferential component to aid in optimizing the parameters of proximity based information acquisition devices and/or systems. For example, where the user regularly scans only near bar codes, an inference can be made to reduce laser power to a low but efficacious level, with or without additional user input. Further, the inferential component can, for example, infer that less power is needed for a night shift than a day shift, or alternately on a rainy day compared to a sunny day, because there is less interference from sunlight during scanning processes. Employing an inferential component can enable highly optimized proximity based information acquisition devices and/or systems.

In accordance with another aspect of the subject innovation, inferential determinations and user inputs can be adjusted based on the quality of the resulting interrogation. The inferential determinations and user inputs can be analyzed independently or in combination. For example, where a user selects a near scan of RFID tags, and the inferential component infers that the user typically is seeking LFRFIDs, a low power scan for LFRFIDs can be performed. Where the interrogation fails, the scan can be adjusted, for example, by increasing the scan power or scanning for additional modalities (e.g., LFRFIDs, HFRFIDs, and UHFRFIDs), among others. Further, this can be done with or without user interaction, for example, adjusting the scan until data is returned, or presenting the user with information and waiting for verification that the correct data has been acquired before adjusting the scan, among many others.

To the accomplishment of the foregoing and related ends, the innovation, then, comprises the features hereinafter fully described and particularly pointed out in the claims. The following description and the annexed drawings set forth in detail certain illustrative embodiments of the innovation. These embodiments can be indicative, however, of but a few of the various ways in which the principles of the innovation can be employed. Other objects, advantages, and novel features of the innovation will become apparent from the following detailed description of the innovation when considered in conjunction with the drawings.

### BRIEF DESCRIPTION OF THE DRAWINGS

FIG. 1 is a high level diagram of a system that can facilitate more optimized proximity based information acquisition in accordance with an aspect of the subject matter disclosed herein.

FIG. 2 is a simplified diagram of a parametric input component that can facilitate more optimized proximity based information acquisition in accordance with an aspect of the subject matter disclosed herein.

FIG. 3 is a diagram of an interrogation condition component that can facilitate more optimized proximity based information acquisition in accordance with an aspect of the subject matter disclosed herein.

FIG. 4 illustrates a diagram of a system employing a dynamic interrogation component that can facilitate more optimized proximity based information acquisition in accordance with an aspect of the disclosed subject matter.

FIG. 5 is a schematic illustration of multiple exemplary interrogation conditions in a system that employs a dynamic interrogation component to facilitate more optimized proximity based information acquisition in accordance with an aspect of the disclosed subject matter.

FIG. 6 illustrates a methodology that facilitates more optimized proximity based information acquisition in accordance with an aspect of the disclosed subject matter.

FIG. 7 illustrates a methodology that facilitates more optimized proximity based information acquisition in accordance with an aspect of the disclosed subject matter.

FIG. 8 illustrates a methodology that facilitates more optimized proximity based information acquisition in accordance with an aspect of the disclosed subject matter.

FIG. 9 illustrates a methodology that facilitates more optimized proximity based information acquisition in accordance with an aspect of the disclosed subject matter.

FIG. 10 illustrates a block diagram of an exemplary electronic device that can utilize dynamic allocation or inferential dynamic allocation of battery capacity in accordance with an aspect of the disclosed subject matter.

### DETAILED DESCRIPTION

The disclosed subject matter is described with reference to the drawings, wherein like reference numerals are used to refer to like elements throughout. In the following description, for purposes of explanation, numerous specific details are set forth in order to provide a thorough understanding of the subject innovation. It is evident, however, that the disclosed subject matter can be practiced without these specific details. In other instances, well-known structures and devices are shown in block diagram form in order to facilitate describing the subject innovation.

Traditional proximity based information acquisition systems and/or devices lack dynamic adjustment of interrogation conditions (e.g., interrogation power, direction, mode, . . . ). Further, conventional systems and devices can result in poorly optimized power consumption, inadequate interrogation, and poor user adaptability, among others, as discussed herein.

In one aspect, a dynamic interrogation component can be employed to facilitate more optimized power consumption in proximity based information acquisition devices and/or systems. For example, a radio frequency information acquisition system and/or device can employ a dynamic interrogation component to dynamically adjust the power of an interrogating radio frequency signal. Adjusting the power of the interrogating radio frequency signal can correspondingly adjust the effective range of the radio frequency interrogation signal. Where the radio frequency interrogation signal is adjusted to be more optimized, power consumption can be optimized.

As an example, where a radio frequency scanning device can acquire data from targets at a distance X with power Y, all targets within X distance can be queried using Y power. Where targets are closer to the scanning device, for example, distance M, and only N power is needed to scan targets within distance M, Y-N power can be conserved.

By conserving power, a smaller power source, for example, a battery, among others, can be used. A smaller power source can reduce user fatigue by reducing weight, reducing charging times, reducing costs, or combination thereof, among many others. Further, where a full sized power supply is used, more optimized power consumption can improve use time and/or reduce the need for recharging, among others.

In another aspect, a dynamic interrogation component can be employed to facilitate more optimized interrogations in proximity based information acquisition devices and/or systems. This can be achieved by, for example, adjusting the power of the interrogating modality. Where, for example, a plurality of targets are located within a distance X from a interrogating device, extraneous data can be returned from targets that are not of interest but are still captured because they are within range. By adjusting the power of the modality, for example, to a less powerful interrogation signal with a distance M, a reduced area can be interrogated and more relevant data can be returned where targets between M and X are not of interest. For example, if an RFID scanner is employed in a pharmacy to read RFID tags associated with different medicines in the pharmacy, scanning for all RFID tags within 3 meters can return a huge amount of data. In contrast, by reducing the RFID scan distance (by, for example, reducing the power to the RFID query antenna, among others) to, for example, 0.2 meters data can be returned for medicines located in close proximity to the scanner while not returning data for all medications between 0.2 and 10 meters.

In another aspect, a dynamic interrogation component can be employed to facilitate more optimized interrogations in proximity based information acquisition devices and/or systems. This can be achieved by, for example, adjusting the directionality of the interrogating modality. For example, on a busy shipping line where RFID systems are used for scanning packages, a spherical scanning modality can result in data acquisition from packages on lines in close proximity. Adjusting the interrogation condition to use a directional RFID interrogation modality can allow only packages in a specific direction (e.g., traveling along a particular package line) to be scanned while packages on lines in close proximity can be rejected because they do not pass through the directional RFID interrogation area.

In another aspect, a dynamic interrogation component can be employed to facilitate more optimized interrogations in proximity based information acquisition devices and/or systems. This can be achieved by selecting alternate interrogation modalities to improve selectivity. For example, low frequency RFIDs (LFRFID), high frequency RFIDs (HFRFID), ultra-high frequency RFIDs (UHFRFID), or combinations thereof, among others, can be selected to include or exclude target data.

In accordance with another aspect of the disclosed subject matter, a device or system end user can interact with the dynamic interrogation component to select parameter(s) appropriate to the particular conditions to aid in optimizing the interrogation condition. For example, graphical user interfaces, function buttons, or trigger pulls, among many others, can enable the user to interact with the dynamic interrogation component to indicate relevant parameters. For example, a user can select distances to the target by a discrete number of trigger pulls, the length of time a trigger is held, or how far a trigger is depressed, among others. Further, a user can select function buttons or icons on a graphical user interface to select, for example, distances to targets, desired modalities (e.g., LFRFID, HFRFID, UHFRFID, . . . ), and/or the directionality of interrogation, among others. One of skill in the art will appreciate that there are nearly a limitless number of methods for a user to interact with a device or system to select the features of the device and/or system as described herein and will further appreciate that all such methods are considered within the scope of the disclosed subject matter.

In another aspect, a dynamic interrogation component can employ inferences to facilitate more optimized proximity based information acquisition devices and/or systems. Contextual information can be harnessed to allow inferences to be determined that can be used to further optimize interrogations. For example, where a user regularly scans at high power in location A and at low power in location B, an inference can be made that as the user transitions from location A to location B the power of the scan should be reduced. Thus, the inference can be employed to optimize the interrogations without requiring additional input from the user. As another example, where a scan is made and data for numerous targets is returned, for example, data from 100 targets, an inference can be made that fewer targets should be acquired and power can correspondingly be reduced to, for example, select a power level that scans an area that returns data on fewer than 10 targets. Inferences can be based on, for example, weather, lighting conditions, time of day, user identity, location, number of targets, types of targets, historical use of the device or system, historic user interactions, or combinations thereof, among many others. One of skill in the art will appreciate that there are nearly a limitless number of inputs to an inferential system and that all of these are considered within the scope of the subject innovation.

In another aspect, a dynamic interrogation component can employ quality analysis to facilitate more optimized proximity based information acquisition devices and/or systems. For example, where a reduced power level is selected by user input and/or inferential determinations, a determination of the quality of the reduced power interrogation can be determined. Thus, where the power level has been adjusted to a lower level and, for example, no targets are acquired, the wrong targets are acquired, or too many targets are acquired, among others, the power level can be determined to have been of insufficient quality and can then be further adjusted to better optimize the interrogation. Thus, where the user selects a lower power level for an RFID scan in a pharmacy and excessive numbers of targets are still returned, the power level can be further reduced in accord with the quality determination.

The subject innovation is hereinafter illustrated with respect to one or more arbitrary architectures for performing the disclosed subject matter. However, it will be appreciated by one of skill in the art that one or more aspects of the subject innovation can be employed in other memory system architectures and is not limited to the examples herein presented.

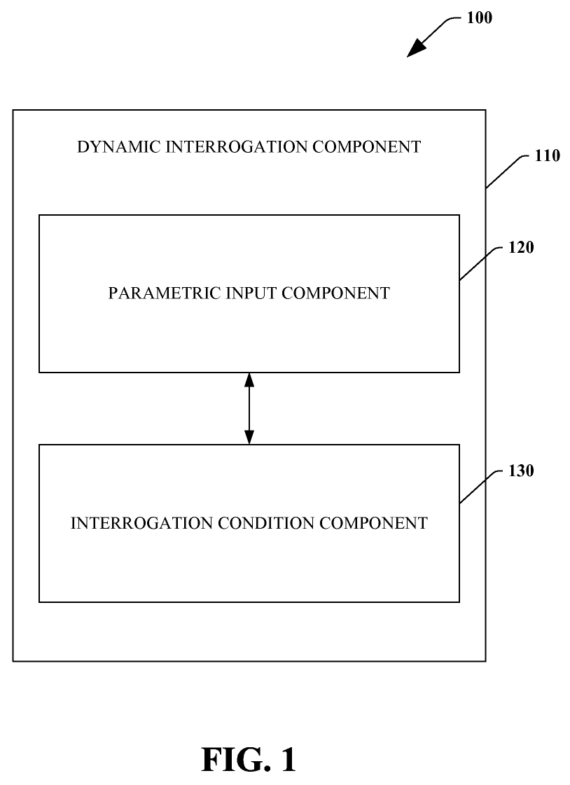

Turning to FIG. 1, illustrated is a system 100 that can facilitate more optimized proximity based information acquisition devices and/or systems in accordance with an aspect of the subject matter disclosed herein. System 100, for example, can result in more optimized power consumption, and/or more optimized target data acquisitions by reducing interrogation ranges, adjusting directionality, and/or adjusting interrogation modalities, among others as described herein.

In an aspect, system 100 can include a dynamic interrogation component 110 that can facilitate interaction with an end user to dynamically adjust the interrogation condition of system 100. Interrogation component 110 can include a parametric input component 120 that can facilitate input of parameters including, but not limited to, the range to targets and/or the direction of targets. For example, a user can input that desired targets are within distance X in any direction.

The parametric input component 120 can further facilitate optimized proximity based information acquisitions based in part on input from a user interface. For example, a user interface can include function buttons, a graphical user interface, semantic motion sensors, trigger buttons, pressure sensors, computer vision systems, line of sight tracking systems, voice interfaces, and the like. Through the user interface, a user can select parameters related to optimizing interrogations as are described herein.

In another aspect, interrogation component 110 can include a parametric input component 120 that can facilitate inferential determinations. Inferences can be based on, for example, direction of targets, range of targets, weather, lighting conditions, time of day, user identity, location, number of targets, types of targets, historical use of the device or system, historic user interactions, or combinations thereof, among many others. Inferential determinations can be employed to better optimize interrogations.

In an aspect, the parametric input component 120 can be communicatively coupled to an interrogation condition component 130 to facilitate optimized proximity based information acquisitions. The interrogation condition component 130 can determine and adjust for a more optimal interrogation. For example, the interrogation condition component 130 can determine the appropriate range, direction, quality level, and/or interrogation modality to employ based at least in part on the parameters received at the parametric input component 120.

As an example, where a user selects for near targets of LFRFID type in system 100 and this information is passed into the parametric input component 120, the parametric input component 120 can further infer, based on historic use by the user, that the interrogation range can be 0.5 meters. These parameters can then be passed to the interrogation condition component 130, where, for example, a spherical interrogation range of 0.5 meters can be set using the LFRFID modality for interrogation of LFRFID targets. Further, for example, where no targets are returned, the interrogation condition component 130 can perform a quality determination and adjust the interrogation range to, for example, 0.75 meters. Where this range returns targets, the new range data can be communicated back to the inferential component (not illustrated) of the parametric input component 120 for incorporation into future inferential determinations. Further, where the user then indicates that the desired target is not in range, the parametric input component 120 can update the inferential component again and pass an enlarged range of 1.0 meters to the interrogation condition component 130, which in response can increase the range to 1.0 meters.

From the example it can be shown that an optimized range and corresponding optimized power consumption can be employed. This can result in additional use time where a battery can be used to power the user device. Additionally, a smaller form factor battery could be used because less power is wasted where power can be optimized. Further, it is illustrated that an inferential component and user inputs can be leveraged to dynamically develop an optimized proximity based information acquisition. Moreover, optimization can include modality selection and directionality of the interrogation. Quality determinations can also be included to aid in the dynamic optimization process.

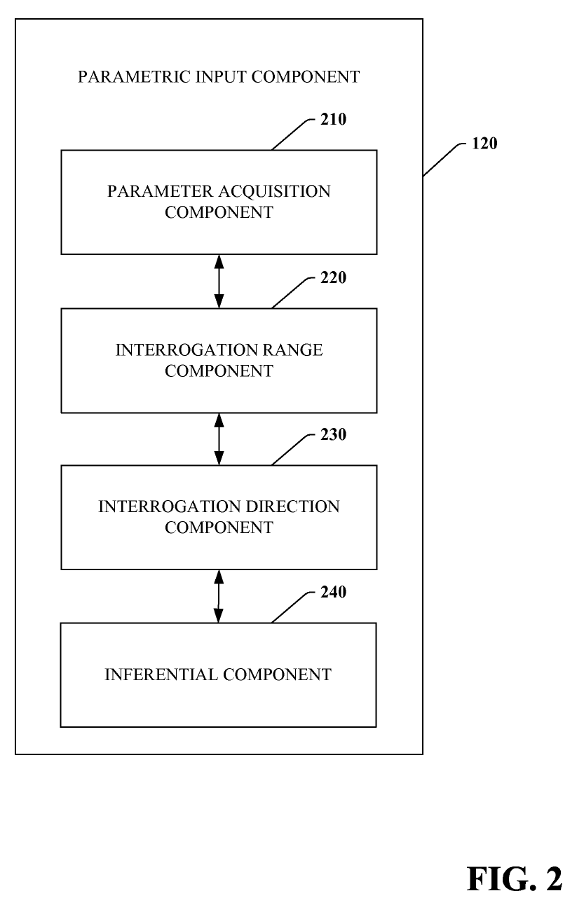

Referring now to FIG. 2, illustrated is a simplified diagram of a parametric input component 120 that can facilitate more optimized proximity based information acquisition in accordance with an aspect of the subject matter disclosed herein. The parametric input component can include a parameter acquisition component 210 to facilitate accepting user input related to parameters for optimizing interrogations. For example, the parameter acquisition component 210 can accept user input related to parameters including range, direction, modality, or combinations thereof, among others.

The parametric input component 120 can also include an interrogation range component 220 and an interrogation direction component 230 that can respectively accept data related to target ranges and directions for use in determining appropriate ranges and directional components of interrogation modalities. For example, where a user has set a parameter of “less than 10 target should be returned”, the interrogation range component 220 and interrogation direction component 230 can be used to determine that a range can be, for example, 1 meter and a direction can be, for example, spherical.

The parametric input component 120 can further include an inferential component 240 to facilitate dynamic proximity based information acquisition. For example, an inferential component can determine an inference, based in part on a location within a facility, for example, related to the modality of interrogation to employ (bar code scanner, RFID scanner, radio frequency scanner, . . . ). The inferential component can base inferences on many forms of information as described herein.

The parametric acquisition component 210, the interrogation range component 220, the interrogation direction component 230, and the inferential component 240 can be communicatively coupled to share information and parameters to facilitate determining an optimized interrogation condition. The optimized interrogation condition can facilitate reduced power consumption and related battery optimizations, and more selective interrogations, among others.

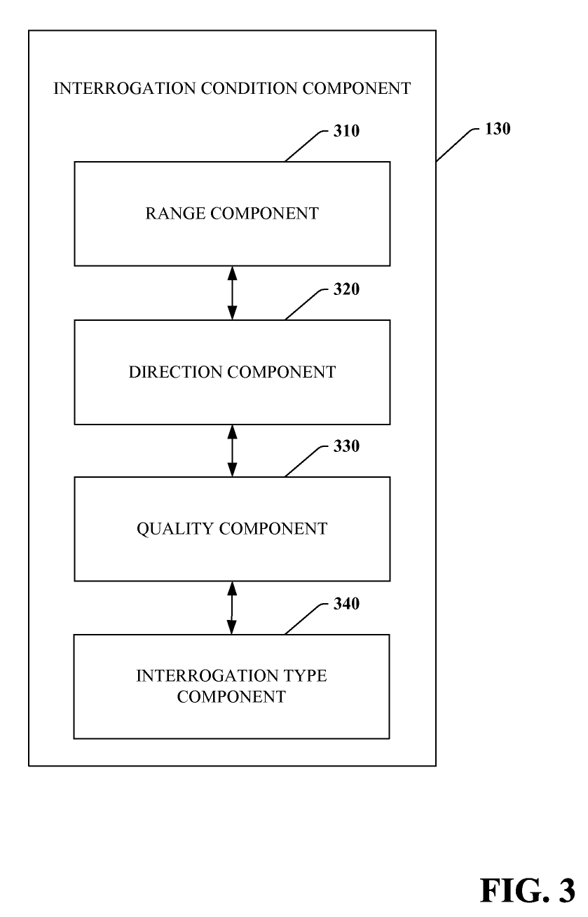

Referring now to FIG. 3, illustrated is an interrogation condition component 130 that can facilitate more optimized proximity based information acquisition in accordance with an aspect of the subject matter disclosed herein. The interrogation condition component 130 can be communicatively coupled to the parametric input component 120 and can receive optimized interrogation condition information therefrom.

In an aspect, the interrogation condition component can include a range component 310 and a direction component 320 that can respectively process range and direction information received from the parametric input component 120. The processed range and direction information can be employed to effect a range and directional condition in an interrogation device or system to facilitate optimized interrogations.

In another aspect, the interrogation condition component 130 can include a quality component 330 that can facilitate the efficacy of the dynamic adjustment of the interrogation. For example, where a reduced laser power is employed to scan barcodes at a near distance from the scanner, the quality component 330 can determine if the power level is sufficient to produce satisfactory data acquisition. Where the quality component 330 determines that the acquired data is not satisfactory, the quality component 330 can indicate to the range component 310 to further increase power to the laser to improve acquired data.

In another aspect, the interrogation condition component 130 can include an interrogation type component that can facilitate determination of the appropriate modality of interrogation to employ. This can be based in part on the parametric data communicated from the parametric input component 120. For example, where a user selects radio frequency interrogation and this parameter is set in the parametric input component 120, this information can be passed to the interrogation type component for selection of an appropriate radio frequency interrogation modality.

Further, the range component 310, direction component 320, quality component 330, and interrogation type component 340 can be communicatively coupled to relay information between the components to facilitate selection of the optimum interrogation condition based in part on the interrogation condition parameters communicated from the parametric input component 120. Further, data can be communicated back to the parametric input component 120 from the interrogation condition component 130 relating to, for example, quality of the interrogation, selected range and directionality conditions, and/or available types of interrogation modalities available, among others. For example, where radio frequency interrogation modalities are receiving substantial interference, this information can be communicated to the parametric input component 120 such that, for example, range conditions can be adjusted to compensate for the interference. A second example can include communications related to the quality determination of the quality component 330 being communicated back to the parametric input component 120 such that, for example, additional inferences can be determined to further optimize the interrogations.

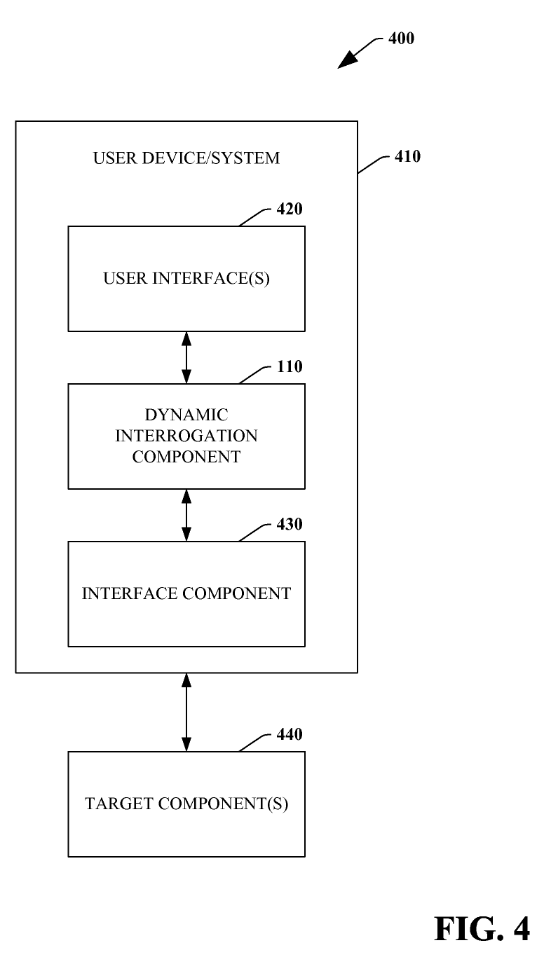

Referring now to FIG. 4, illustrated is a diagram of a system 400 employing a dynamic interrogation component 110 that can facilitate optimized proximity based information acquisition in accordance with an aspect of the disclosed subject matter. A user device/system 410 can include one or more user interfaces 420 that can be communicatively coupled to the dynamic interrogation component 110 to facilitate input of user parameters and data. For example, a user can “log on” to the user device/system 410 and such identity can be communicated to the dynamic interrogation component 110 such that inferences based on this particular user's historic device/system usage can be determined. The user interface can include, for example, graphical user interfaces, triggers, function buttons, and numerous others as described herein.

The dynamic interrogation component 110 can be communicatively coupled to an interface component 430. For example, where dynamic interrogation conditions have been determined in the dynamic interrogation component 110, this information can be passed to the interface component to effect the optimized interrogation with target component(s) 440. Interface components 430 can include RFID and radio frequency broadcast systems, laser barcode readers, optical readers, microwave transmission systems, and the like.

In an aspect, target component(s) 440 can include 1-dimensional barcodes, 2-dimensional barcodes, holograms, RFID tags, radio frequency tags, and the like. Typically, target component(s) 440 are related to one or more interface component 430 modalities such that the interface component modality can be selected for use in interrogations by the user device/system 410. Further, where the interface component 430 and target component(s) 440 are suitably related, employing a dynamic integration component can facilitate optimized proximity based information acquisition as described herein.

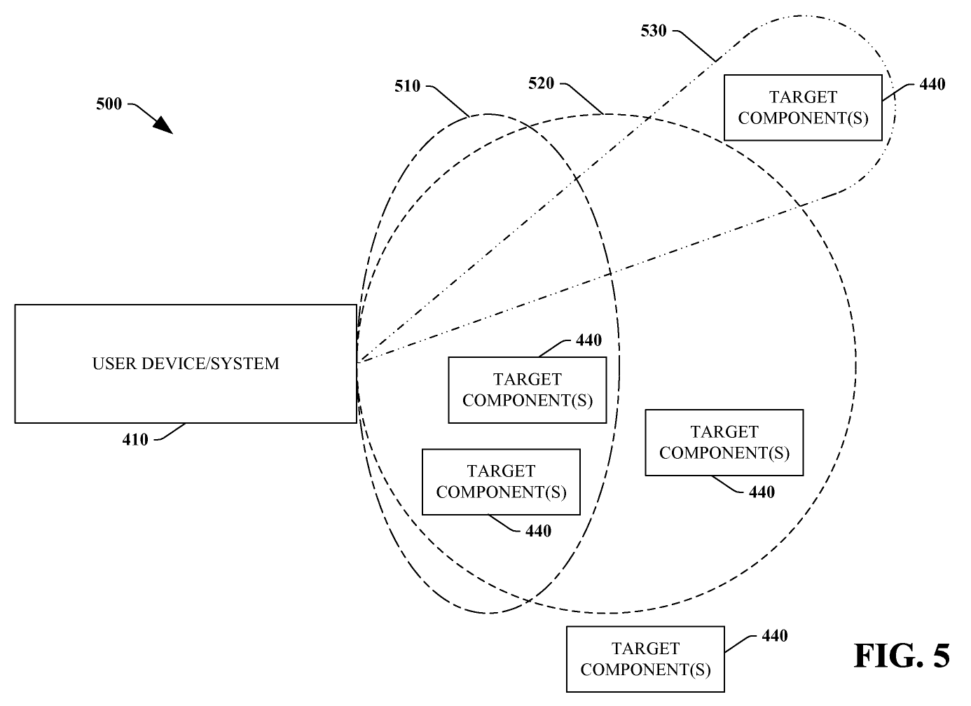

Referring now to FIG. 5, a schematic illustration of multiple exemplary interrogation conditions in a system 500 that employs a dynamic interrogation component (integral to user device/system 410) to facilitate more optimized proximity based information acquisition in accordance with an aspect of the disclosed subject matter is presented. In an aspect, user device/system 410 can include a dynamic interrogation component 110. Based on a determination of an optimized interrogation condition, user device/system 410 can enable an optimized interrogation of target component(s) 440.

In an aspect, target component(s) can be distributed spatially as depicted in FIG. 5. By employing various interrogation ranges, interrogation directionality, and interrogation modalities, targets can be more selectively interrogated and power consumption can be optimized. For example, an interrogation condition represented by dashed line 510 can be, for example, a reduced range interrogation such that less power is consumed and only data from near targets is acquired.

As second example, an interrogation condition represented by dashed line 520 can represent, for example, a full range interrogation such that as many targets as are in range can be interrogated. In this second example it can be noted that several targets fall outside of even the full power range of the user device/system 410. It can further be noted that in full range interrogations the user device/system can consume similar power to a traditional device or system and can provide similar selectivity to a traditional system. This is in contrast to the first example represented by dashed line 510 in which less power is used and higher selectivity is achieved.

As a third example, an interrogation condition represented by dashed line 530 can represent, for example, a full range directional interrogation such that range can, for example, actually be extended beyond a typical full range spherical interrogation. Further, example 530 illustrates that highly selective interrogation can be achieved with directional interrogations. For instance, closer targets are ignored because they are outside of the directed interrogation cone 530.

One of skill in the art will appreciate that numerous interrogation systems can be dynamically adjusted to facilitate some or all of the aspects of the subject innovations and as such all such interrogations systems amenable to dynamic adjustment are considered within the scope of the disclosed subject matter. These interrogations systems can include, but are not limited to, RFID, barcode readers, optical readers, radio frequency readers, microwave readers, radar systems, sonar systems, and various communications systems, among others.

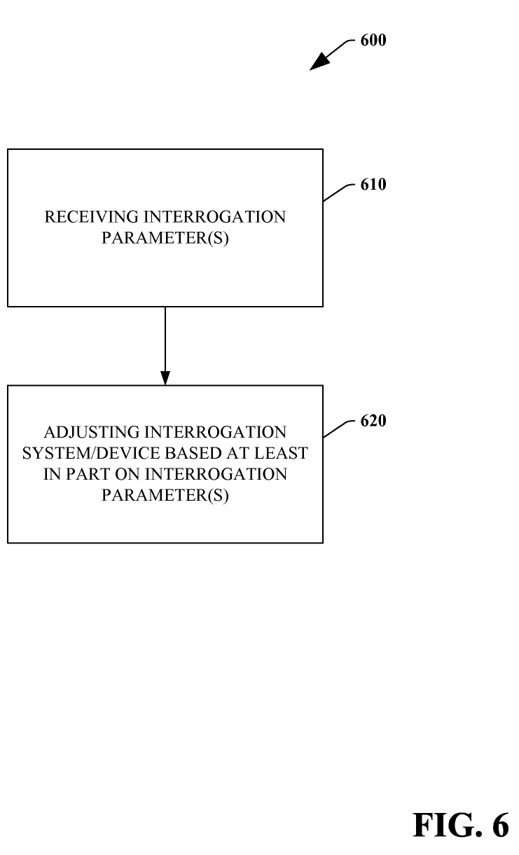

FIGS. 6-9 illustrate methodologies, flow diagrams, and/or timing diagrams in accordance with the disclosed subject matter. It is to be appreciated that the methodologies presented herein can incorporate actions pertaining to a neural network, an expert system, a fuzzy logic system, and/or a data fusion component, or a combination of these, which can generate diagnostics indicative of the optimization of proximity based information acquisition operations germane to the disclosed methodologies. Further, the prognostic analysis of this data can serve to better optimize proximity based information acquisition operations, and can be based on real time acquired data or historical data within a methodology or from components related to a methodology herein disclosed, among others. It is to be appreciated that the subject invention can employ highly sophisticated diagnostic and prognostic data gathering, generation and analysis techniques, and such should not be confused with trivial techniques such as arbitrarily employing a lower power setting in response to simple methodology inputs.

For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states by way of a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 6, illustrated is a methodology 600 that facilitates optimized proximity based information acquisition in accordance with an aspect of the disclosed subject matter. Conventionally, proximity information acquisition methods employ fixed range and directional interrogation parameters. These conventional methodologies frequently do not optimize power consumption or target selectivity. For example, a typical RFID interrogation method can interrogate RFID targets within, for example, 3 meters. This can result in wasted power where less power could be used to interrogate targets of interest where those targets are located closer to the interrogation device, for example, 0.1 meters. Further, where a larger area in interrogated, extraneous information can be acquired. For example, where only data related to near targets is desired by a user, traditional methodologies can return data from both near and far targets.

The methodology 600 can facilitate reduced power consumption and higher target selectivity by dynamically adjusting interrogation parameters, such as, range, directionality, and modality, among others. At 610, methodology 600 can receive interrogation parameters to facilitate dynamically adjusting interrogations. For example, at 610, system 600 can receive user input parameter selections. These can include, for example, target range, target direction, and target modality type, among others. As a second example, at 610, inferred parameters can be received. These inferred parameters can be determined by, for example, an inferential component 240. The inferences can be based on data sources as described herein.

At 615, methodology 600 can dynamically adjust the interrogation system/device based at least in part on the received interrogation parameters, among others. Dynamically adjusting the interrogation system/device can include, among others, setting an interrogation range, setting a directional component of an interrogation, or selecting a mode of interrogation. For example, a range can be set at 1 meter, a direction can be set as spherical, and a modality can be set as UHFRFID. At this point, methodology 600 can end.

In an aspect of the disclosed invention, the adjustment of the interrogation system/device can further include determining the quality of the interrogation and further adjustment based thereon as described herein. In another aspect, user inputs can be generated by numerous user input systems as described herein. Additionally, in an aspect, a system or device can employ multiple modalities that need not be related, for example, RFID, bar code scanners, microwave scanners, radio frequency scanners, radar, sonar, or combinations thereof, among many others amenable to dynamic adjustment of the interrogation system as described herein.

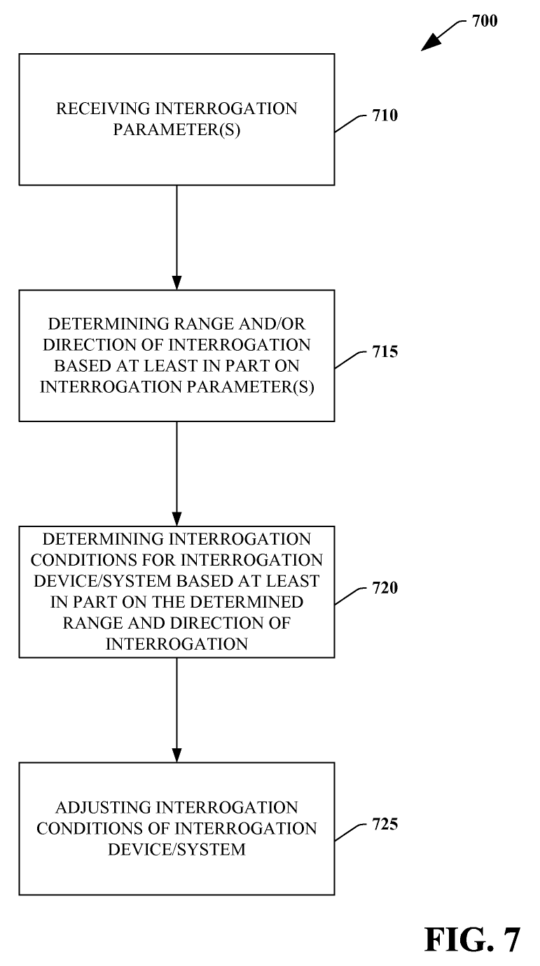

Referring now to FIG. 7, illustrated is a methodology 700 that facilitates more optimized proximity based information acquisition in accordance with an aspect of the disclosed subject matter. At 710, interrogation parameters can be received, for example, user input parameters or inferential parameter determinations, among others, as discussed herein. At 715, an interrogation range and/or an interrogation directionality component can be determined based at least in part on the received interrogation parameters.

At 720, interrogation conditions can be determined based in part on the determined range and/or direction. For example, where a user has selected interrogation of far targets, this parameter can be received at 710 and passed to 715 where a spherical direction can be inferred. The far target parameter and spherical direction determination can be employed to determine the interrogation conditions at 720. At 725, the determined interrogation conditions can be set, for example, interface component 430 can be adjusted to said conditions. After this, method 700 can end.

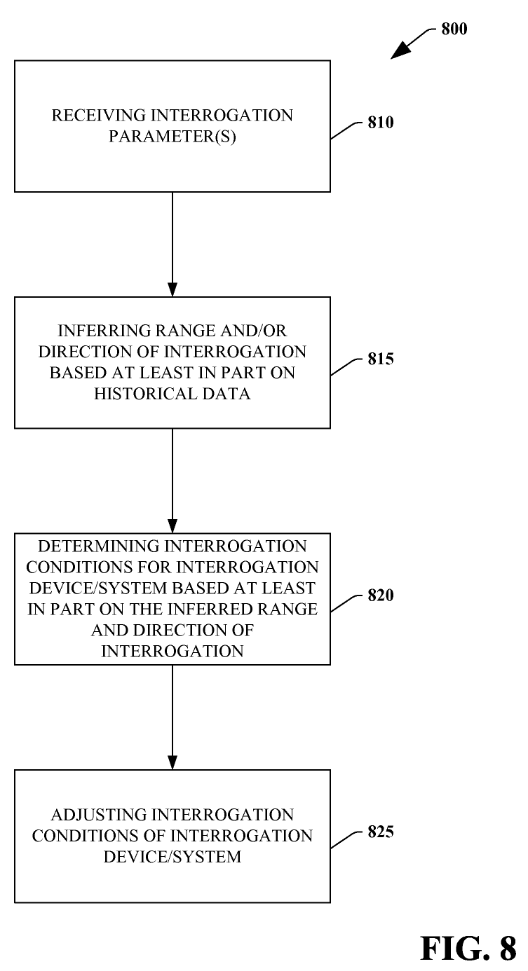

Referring now to FIG. 8, illustrated is a methodology 800 that facilitates more optimized proximity based information acquisition in accordance with an aspect of the disclosed subject matter. At 810 interrogation parameters can be received, for example, user input parameters or inferential parameter determinations, among others, as discussed herein. At 815, an interrogation range and/or an interrogation directionality component can be inferred based at least in part on the received interrogation parameters. Additional data can be included in said inference (e.g., user history, location, time, weather, . . . ) as discussed herein.

At 820, interrogation conditions can be determined based in part on the inferred range and/or direction. For example, where a user has selected interrogation of near targets, this parameter can be received at 810 and passed to 815 where a targeted direction can be inferred based on, for example, prior user actions relating to interrogation of near targets. The near target parameter and targeted direction determination can be employed to determine the interrogation conditions at 820. At 825, the determined interrogation conditions can be set, for example, interface component 430 can be adjusted to said conditions. After this, method 800 can end.

It is to be appreciated that more complex inferential determinations can be made regarding interrogation conditions as discussed at length herein. It is to be further appreciated that different interrogation conditions can be determined in response to these inferential determinations as also discussed at length herein. All such modifications of method 800 are considered to be within the scope of the disclosed subject matter.

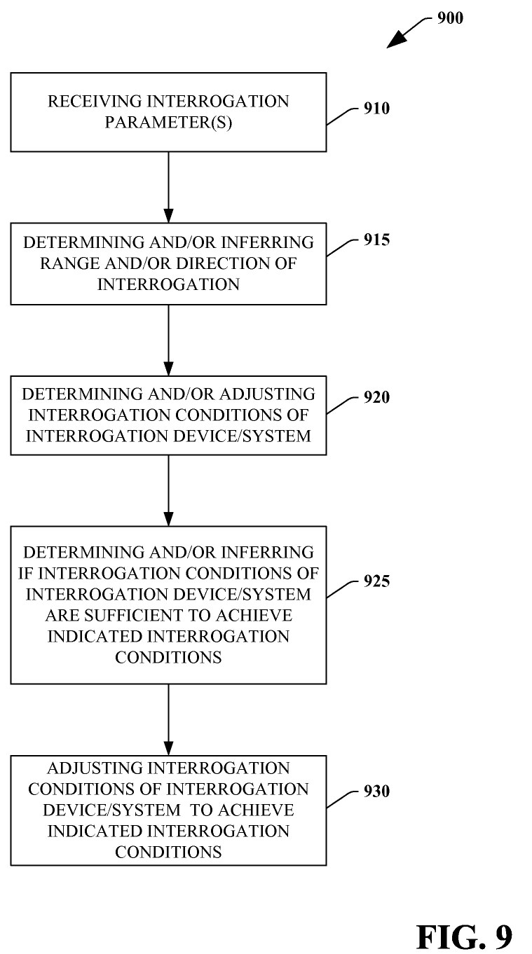

Referring now to FIG. 9, illustrated is a methodology 900 that facilitates more optimized proximity based information acquisition in accordance with an aspect of the disclosed subject matter. At 910, interrogation parameters can be received as discussed herein. At 915, range and/or direction parameters can be determined or inferred as discussed herein. At 920, the interrogation conditions can be determined and employed, for example, interface component 430 can be adjusted to said determined conditions.

At 925, a determination or inference can be made regarding the quality of the interrogation conditions employed in action block 920. For example, where an interrogation condition results in the return of data from targets that satisfy the user, no further adjustment of the interrogation condition can be undertaken in future actions. As a second example, where the number of returned target data is excessively large, the quality of the interrogation condition may be determined to be poor and adjustment thereof can be desirable, for example, adjusting a spherical directional component to a targeted directional component to improve selectivity can be desired, among others. At 930, based at least in part on the determination of interrogation quality in action block 925, the interrogation conditions can be adjusted accordingly. After this, method 900 can end.

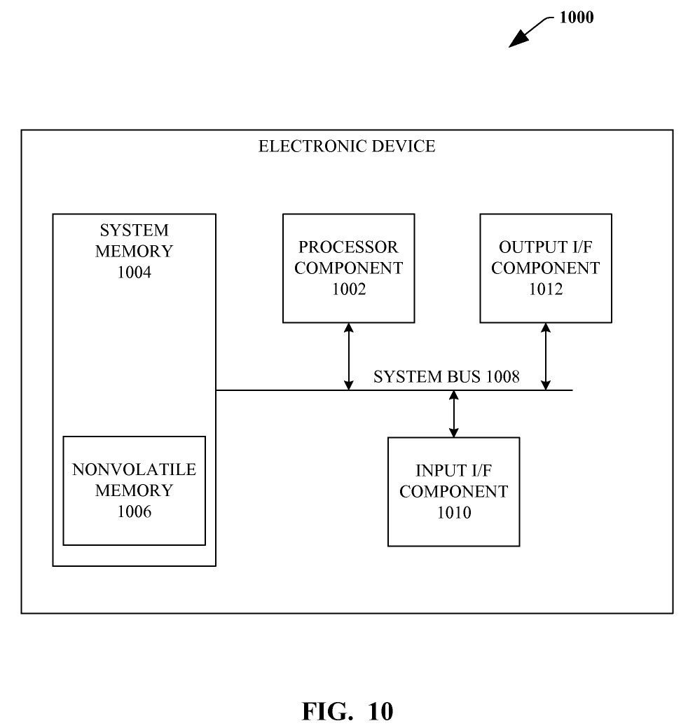

Referring to FIG. 10, illustrated is a block diagram of an exemplary, non-limiting electronic device 1000 that can include an optimized proximity based information acquisition system and/or device that can dynamically adjust the interrogation conditions to improve power consumption and target selectivity in accordance with one aspect of the disclosed subject matter. The electronic device 1000 can include, but is not limited to, a computer, a laptop computer, RFID devices, barcode scanners, optical scanners, directional radio frequency devices, microwave interrogation devices, radar, sonar, network equipment (e.g. routers, access points), a media player and/or recorder (e.g., audio player and/or recorder, video player and/or recorder), a television, a smart card, a phone, a cellular phone, a smart phone, an electronic organizer, a PDA, a portable email reader, a digital camera, an electronic game (e.g., video game), an electronic device associated with digital rights management, a Personal Computer Memory Card International Association (PCMCIA) card, a trusted platform module (TPM), a Hardware Security Module (HSM), set-top boxes, a digital video recorder, a gaming console, a navigation system (e.g., global position satellite (GPS) system), secure memory devices with computational capabilities, devices with tamper-resistant chips, an electronic device associated with an industrial control system, an embedded computer in a machine (e.g., an airplane, a copier, a motor vehicle, a microwave oven), and the like.

Components of the electronic device 1000 can include, but are not limited to, a processor component 1002, a system memory 1004 (with nonvolatile memory 1006), and a system bus 1008 that can couple various system components including the system memory 1004 to the processor component 1002. The system bus 1008 can be any of various types of bus structures including a memory bus or memory controller, a peripheral bus, or a local bus using any of a variety of bus architectures.

Electronic device 1000 can typically include a variety of computer readable media. Computer readable media can be any available media that can be accessed by the electronic device 1000. By way of example, and not limitation, computer readable media can comprise computer storage media and communication media. Computer storage media can include volatile, non-volatile, removable, and non-removable media that can be implemented in any method or technology for storage of information, such as computer readable instructions, data structures, program modules or other data. Computer storage media includes, but is not limited to, RAM, ROM, EEPROM, nonvolatile memory 1006 (e.g., flash memory), or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by electronic device 1000. Communication media typically can embody computer readable instructions, data structures, program modules or other data in a modulated data signal such as a carrier wave or other transport mechanism and includes any information delivery media.

The system memory 1004 can include computer storage media in the form of volatile and/or nonvolatile memory 1006. A basic input/output system (BIOS), containing the basic routines that help to transfer information between elements within electronic device 1000, such as during start-up, can be stored in memory 1004. Memory 1004 can typically contain data and/or program modules that can be immediately accessible to and/or presently be operated on by processor component 1002. By way of example, and not limitation, system memory 1004 can also include an operating system, application programs, other program modules, and program data.

The nonvolatile memory 1006 can be removable or non-removable. For example, the nonvolatile memory 1006 can be in the form of a removable memory card or a USB flash drive. In accordance with one aspect, the nonvolatile memory 1006 can include flash memory (e.g., single-bit flash memory, multi-bit flash memory), ROM, PROM, EPROM, EEPROM, or NVRAM (e.g., FeRAM), or a combination thereof, for example. Further, the flash memory can be comprised of NOR flash memory and/or NAND flash memory.

A user can enter commands and information into the electronic device 1000 through input devices (not shown) such as a keypad, function buttons, trigger, microphone, graphical user interface, tablet or touch screen although other input devices can also be utilized. These and other input devices can be connected to the processor component 1002 through input interface component 1012 that can be connected to the system bus 1008. Other interface and bus structures, such as a parallel port, game port or a universal serial bus (USB) can also be utilized. A graphics subsystem (not shown) can also be connected to the system bus 1008. A display device (not shown) can be also connected to the system bus 1008 via an interface, such as output interface component 1012, which can in turn communicate with video memory. In addition to a display, the electronic device 1000 can also include other peripheral output devices such as speakers (not shown), which can be connected through output interface component 1012.

It is to be understood and appreciated that the computer-implemented programs and software can be implemented within a standard computer architecture. While some aspects of the disclosure have been described above in the general context of computer-executable instructions that may run on one or more computers, those skilled in the art will recognize that the technology also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices (e.g., PDA, phone), microprocessor-based or programmable consumer electronics, and the like, each of which can be operatively coupled to one or more associated devices.

The illustrated aspects of the disclosure may also be practiced in distributed computing environments where certain tasks are performed by remote processing devices that are linked through a communications network. In a distributed computing environment, program modules can be located in both local and remote memory storage devices.

As utilized herein, terms “component,” “system,” “interface,” and the like, can refer to a computer-related entity, either hardware, software (e.g., in execution), and/or firmware. For example, a component can be, but is not limited to being, a process running on a processor, a processor, a circuit, a collection of circuits, an object, an executable, a thread of execution, a program, and/or a computer. By way of illustration, both an application running on a server and the server can be a component. One or more components can reside within a process and a component can be localized on one computer and/or distributed between two or more computers.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the disclosed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

### Artificial Intelligence

Artificial intelligence based systems (e.g., explicitly and/or implicitly trained classifiers) can be employed in connection with performing inference and/or probabilistic determinations and/or statistical-based determinations as in accordance with one or more aspects of the disclosed subject matter as described herein. As used herein, the term “inference,” “infer” or variations in form thereof refers generally to the process of reasoning about or inferring states of the system, environment, and/or user from a set of observations as captured through events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the disclosed subject matter.

For example, an artificial intelligence based system can evaluate current or historical evidence associated with data access patterns (e.g., a device user generally users an RFID scanner in a medium range mode, among many others, user interactions, environmental data (e.g., determining location, weather, time of day, . . . ), or combinations thereof, among others, . . . ) and based in part in such evaluation, can render an inference, based in part on probability, regarding, for instance, interrogation modalities, interrogation ranges, interrogation directionalities, desired target selectivity, optimal ranges for predicted device use over a battery life, interrogational quality, or many others. One of skill in the art will appreciate that intelligent and/or inferential systems can facilitate further optimization of the disclosed subject matter and such inferences can be based on a large plurality of data and variables all of with are considered within the scope of the subject innovation.

What has been described above includes examples of aspects of the disclosed subject matter. It is, of course, not possible to describe every conceivable combination of components or methodologies for purposes of describing the disclosed subject matter, but one of ordinary skill in the art will recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim.

What is claimed is:

1. A system that facilitates proximity based information acquisition comprising:
a parametric input component that can receive at least one parameter related to interrogation of a target; and
an interrogation condition component that can at least adjust an area comprising an interrogation range, based at least in part on a parametric input.

2. The system of claim 1, in which the interrogation component can further adjust the directionality of the area comprising the interrogation range.

3. The system of claim 1, in which the interrogation component can further adjust the modalities of interrogation.

4. The system of claim 3, wherein the modalities include radio frequency identification (RFID) interrogation, directional radio frequency interrogation, laser barcode interrogation, optical barcode interrogation, holographic interrogation, or combinations thereof and the like.

5. The system of claim 1, further comprising an inferential component that can at least determine inferences relating to interrogation conditions.

6. The system of claim 1, further comprising a quality component that can at least determine the quality of the interrogation conditions.

7. The system of claim 1, further comprising a user interface component.

8. The system of claim 7, wherein the user interface component further comprises an on/off trigger input.

9. The system of claim 7, wherein the user interface component further comprises a variable trigger input.

10. The system of claim 7, wherein the user interface component further comprises a graphical user interface, function buttons or the like, motion sensors, pressure sensors, or combinations thereof and the like.

11. An electronic device comprising the system of claim 1.

12. The electronic device of claim 11, wherein the electronic device comprises at least one of a computer, a laptop computer, RFID reader, barcode reader, network equipment, a media player, a media recorder, a television, a smart card, a phone, a cellular phone, a smart phone, an electronic organizer, a personal digital assistant, a portable email reader, a digital camera, an electronic game, an electronic device associated with digital rights management, a Personal Computer Memory Card International Association (PCMCIA) card, a trusted platform module (TPM), a Hardware Security Module (HSM), set-top boxes, a digital video recorder, a gaming console, a navigation system, a secure memory device with computational capabilities, a device with at least one tamper-resistant chip, an electronic device associated with industrial control systems, or an embedded computer in a machine, or a combination thereof, wherein the machine comprises one of an airplane, a copier, a motor vehicle, or a microwave oven.

13. A method that facilitates optimized proximity based information acquisition comprising:
receiving at least one parameter relating to interrogating target components;
adjusting interrogation conditions based at least in part on the received at least one parameter; and
wherein the at least one parameter is related to an area comprising an interrogation range, related to the directionality of an area comprising an interrogation range, or related to modalities of interrogating target components.

14. The method of claim 13, further comprising determining additional parameters based at least in part on the received at least one parameters.

15. The method of claim 14, further comprising determining an interrogation condition based on the additional parameters.

16. The method of claim 15, further comprising adjusting the operating interrogation conditions of an interrogation device, system, or combination thereof, based at least in part on the determined interrogation condition.

17. The method of claim 13, further comprising inferring additional parameters based at least in part on historical data.

18. The method of claim 13, further comprising determining the quality of the interrogation conditions based at least in part on the results of an interrogation performed under the interrogation conditions.

19. The method of claim 18, wherein the determination of quality is at least in part based on an inference about the sufficiency of the data results.

20. The method of claim 18, further comprising adjusting the interrogation conditions to improve the quality of an interrogation performed under the adjusted interrogation conditions.
